(19) United States
(12) Patent Application Publication
(10) Pub. No.: US 2009/0002472 A1
(43) Pub. Date: Jan. 1, 2009

(54) Thermal Print Head Temperature Estimation System

(76) Inventors: Suhail S. Saquib, Shrewsbury, MA (US); Brian Busch, Sudbury, MA (US)

Correspondence Address: ROBERT PLOTKIN, PC, 45 BUTTERNUT CIRCLE, CONCORD, MA, 01742-1937, US

(21) Appl. No.: 11/957,650

(22) Filed: Dec. 17, 2007

Related U.S. Application Data
(62) Division of application No. 11/524,476, filed on Sep. 20, 2006, now Pat. No. 7,328,980.
(60) Provisional application No. 60/718,859, filed on Sep. 20, 2005.

(51) Int. Cl. B41J 2/00

(52) U.S. Cl. 347/192

(57) ABSTRACT

A method estimates the temperature of a thermal print head element during printing. In one embodiment, the temperature is estimated using the resistance of the thermal print head element, which typically changes with the print head element temperature. The change in resistance of the print head element is exploited to indirectly estimate the temperature of the print head element.

### CROSS REFERENCE TO RELATED APPLICATIONS

This application is a divisional of U.S. patent application Ser. No. 11/524,476, filed on Sep. 20, 2006, entitled “Thermal Print Head Temperature Estimation System,” which claims the benefit of U.S. Provisional Patent Application Ser. No. 60/718,859, filed on Sep. 20, 2005, entitled “Thermal Print Head Temperature Estimation System,” both of which are hereby incorporated by reference.

### BACKGROUND

1. Field of the Invention

The present invention relates to thermal imaging processes and, more particularly, to techniques for estimating the temperature of thermal print head elements during thermal imaging processes.

2. Related Art

Thermal printers typically contain thermal print head (TPH) having a linear array of heating elements (also referred to herein as “print head elements”) that print on an output medium by, for example, transferring pigment from a donor sheet to the output medium or by initiating a color-forming reaction in the output medium. The output medium is typically a porous receiver receptive to the transferred pigment, or a paper coated with the color-forming chemistry. Each of the print head elements, when activated, forms color on the medium passing underneath the print head element, creating a spot having a particular density. Regions with larger or denser spots are perceived as darker than regions with smaller or less dense spots. Digital images are rendered as two-dimensional arrays of very small and closely-spaced spots.

A thermal print head element is activated by providing it with energy. Providing energy to the print head element increases the temperature of the print head element, causing either the transfer of colorant to the output medium or the formation of color in the output medium. The density of the output produced by the print head element in this manner is a function of the amount of energy provided to the print head element. The amount of energy provided to the print head element may be varied by, for example, varying the amount of power provided to the print head element within a particular time interval or by providing power to the print head element for a longer time interval.

One problem with conventional thermal printers results from the fact that their print head elements retain heat after the conclusion of each print head cycle. This retention of heat can be problematic because, in some thermal printers, the amount of energy that is delivered to a particular print head element during a particular print head cycle is calculated based on an assumption that the temperature of the print head element at the beginning of the print head cycle is a known fixed temperature. Since, in reality, the temperature of the print head element at the beginning of a print head cycle depends on (among other things) the amount of energy delivered to the print head element during previous print head cycles, the actual temperature achieved by the print head element during a print head cycle may differ from the calibrated temperature, thereby resulting in a higher or lower output density than is desired. Further complications are similarly caused by the fact that the current temperature of a particular print head element is influenced not only by its own previous temperatures—referred to herein as its “thermal history”—but by the ambient (room) temperature and the thermal histories of other print head elements in the print head.

As may be inferred from the discussion above, in some conventional thermal printers, the average temperature of each particular thermal print head element tends to gradually rise during the printing of a digital image due to retention of heat by the print head element and the over-provision of energy to the print head element in light of such heat retention. This gradual temperature increase results in a corresponding gradual increase in density of the output produced by the print head element, which is perceived as increased darkness in the printed image. This phenomenon is referred to herein as “density shift.”

Furthermore, conventional thermal printers typically have difficulty accurately reproducing sharp density gradients between adjacent pixels in both the fast scan and slow scan direction. For example, if a print head element is to print a white pixel following a black pixel, the ideally sharp edge between the two pixels will typically be blurred when printed. This problem results from the amount of time that is required to raise the temperature of the print head element to print the black pixel after printing the white pixel. More generally, this characteristic of conventional thermal printers results in less than ideal sharpness when printing images having regions of high density gradient.

Various improved techniques exist for controlling the temperature of print head elements in a thermal printer to more accurately render digital images. Examples of such techniques have been described in U.S. Pat. No. 6,819,347 and in co-pending U.S. patent application Ser. No. 10/910,880, filed Aug. 4, 2004 (published as U.S. Pat. App. Pub. No. US 2005/0007438) and U.S. patent application Ser. No. 10/988,896, filed Nov. 15, 2004 (published as U.S. Pat. App. Pub. No. US 2005/0068404).

Although such techniques have been effective to provide improved thermal images, nevertheless further improvements would be desirable, particularly in the thermal history control parameters. What is needed are techniques for estimating the unknown temperature of thermal print head elements during the imaging processes using the thermal print head.

### SUMMARY

A method estimates the temperature of a thermal print head element. In one embodiment, the temperature is estimated using the resistance of the thermal print head element, which typically changes with the print head element temperature. The change in resistance of the print head element is exploited to indirectly estimate the temperature of the print head element.

The method employs a model for the temperature rise when energy is applied to the thermal print head element in conjunction with a model for mapping the resistance to temperature. The parameters of the model are obtained directly from the resistance measurements using a maximum likelihood estimator. It has been found that the MLE for jointly estimating the temperature model and resistance-temperature mapping tends to be biased. The factors which contribute to this bias have been identified and an analytical expression for the bias has been derived.

The resistance-temperature mapping of the thermal print head elements is estimated from resistance measurements made over a limited range of thermal print head heat sink temperatures. This model-based approach is capable of providing the functional relationship between the resistance of a thermal print head element and its temperature for temperatures much higher than those to which the heat sink can be heated without damaging the thermal print head.

In one aspect of the invention there is provided a method for estimating the temperature of a thermal print head element which includes collecting data and estimating parameters. The data collection may include setting an oven or other insulated chamber containing the thermal print head to a desired temperature, allowing the print head to thermally equilibrate with the oven temperature, applying energy to the thermal print head element to heat it (such as by turning on current to the print head element for a fixed duration and at a fixed power level), applying a probing pulse to the thermal print head element to obtain resistance measurements, and repeating these steps for different oven temperatures and applied powers.

The parameter estimation may include estimating a parameter A of the temperature model, and estimating the resistance-temperature mapping f(·) by minimizing the weighted mean square temperature error between the two models, and repeating and refining these estimations by using the estimate of f(·) to recompute the weights.

The estimated temperature model parameter A represents the temperature rise in the thermal print head element when unity power is applied to the print head element for a fixed duration. Manufacturing tolerances in the different coatings of the thermal print head may result in different temperature rises between print heads for the same applied power. These differences may lead to varying print head responses and need to be calibrated out to ensure consistent image quality across printers. The estimated A may be utilized to achieve this compensation. For example, the power P applied to the print head element may be set such that PA remains constant from print head to print head, or from print head element to print head element.

The normalized resistance-temperature mapping is a characteristic of the material used to construct the print head elements. Once estimated for a single print head, it may be used on other print heads to infer the temperature of the heating elements by measuring their electrical resistance. Such a measurement may be conducted on-line while printing to compensate for the temperature rise of the print head or off-line to learn the parameters of a thermal history compensation algorithm.

In one aspect of the invention, a method is provided for identifying an estimate \hat{f}(·) of a function Tₕ=f(Rₕ) relating resistance Rₕ of a thermal print head element in a thermal print head of a thermal printer to temperature Tₕ of the thermal print head element. The method includes: (A) selecting a plurality N of initial temperatures Tₛᵢ; (B) heating an insulated chamber containing the thermal print head to the plurality of initial temperatures Tₛᵢ; (C) providing the thermal print head element with a plurality N of input energies Pᵢ; (D) measuring a plurality N of resistances Rₕᵢ resulting from application of the plurality of input powers Pᵢ; and (E) identifying the estimate \hat{F}(·) based on the plurality of initial temperatures Tₛᵢ, the plurality of resistances Rₕᵢ, and the plurality of input powers Pᵢ.

In another aspect of the present invention, a method is provided which includes: (A) identifying a first plurality of estimates of a parameter A for a first plurality of print head elements in a first thermal print head, wherein the equation Tₕ=Tₛ+AP relates thermal print head element temperature Tₕ to a heat sink temperature T and input power P; (B) identifying a first average value of the first plurality of estimates; (C) identifying a second plurality of estimates of the parameter A for a second plurality of print head elements in a second thermal print head; (D) identifying a second average value of the second plurality of estimates; and (E) adjusting a first input energy provided to the first thermal print head and a second input energy provided to the second thermal print head based on a function of the first average value and the second average value.

In yet another aspect of the present invention, a method is provided which includes: (A) identifying a first estimate of a parameter A for a first print head element in a first thermal print head, wherein the equation Tₕ=Tₛ+AP relates thermal print head element temperature Tₕ to a heat sink temperature Tₛ and input power P; (B) identifying a second estimate of the parameter A for a second print head element in the first thermal print head; and (C) adjusting a first input energy provided to the first thermal print head element and a second input energy provided to the second thermal print head element based on a function of the first estimate and the second estimate.

In still a further aspect of the present invention, a method is provided for estimating a temperature Tₕ of a print head element in a thermal print head. The method includes: (A) identifying an estimate \hat{f}(·) of a function Tₕ=f(Rₕ) relating print head element resistance Rₕ to print head element temperature Tₕ; (B) identifying a resistance Rₕ of the print head element; and (C) estimating the temperature Tₕ of the print head element based on the estimate \hat{f}(·) and the resistance Rₕ.

Other features and advantages of various aspects and embodiments of the present invention will become apparent from the following description and from the claims.

### BRIEF DESCRIPTION OF THE DRAWINGS

FIG. 1 is a diagram of a conventional thermal print head and its output;

FIG. 2 is a flowchart of a method performed according to one embodiment of the present invention to generate a resistance-temperature mapping for a particular thermal print head element in a thermal print head;

FIG. 3 is a schematic diagram of a resistance measurement apparatus according to one embodiment of the present invention;

FIGS. 4-10 are flowcharts of methods for obtaining an estimate of a resistance-measurement function according to one embodiment of the present invention;

FIGS. 11A shows the ground truth temperature vs. resistance function for a heating element used to generate synthetic data according to one embodiment of the present invention;

FIG. 11B shows resistance measurements made at different heat-sink temperatures and applied powers according to one embodiment of the present invention;

FIG. 12 shows an estimated resistance-temperature function using different order polynomials according to one embodiment of the present invention;

FIG. 13 shows experimental results obtained using piecewise polynomial approximation techniques according to one embodiment of the present invention;

FIG. 14 compares spline fits to the ground truth when the spline fits are used to improve the results of polynomial approximations according to one embodiment of the present invention;

FIG. 15 shows an estimate resistance-temperature function for a spline model according to one embodiment of the present invention;

FIG. 16A shows data collected on a particular thermal print head according to one embodiment of the present invention;

FIG. 16B shows the fits for two heating elements using a piecewise linear model according to one embodiment of the present invention;

FIG. 17A shows a second order spline fit to resistance and reconstructed temperature sample pairs of FIG. 16B according to one embodiment of the present invention;

FIG. 17B shows an approximated resistance-temperature function as a function of normalized resistance according to one embodiment of the present invention;

FIG. 18 is a flowchart of a method for using an estimated resistance-temperature function to predict a temperature of a thermal print head element based on its resistance according to one embodiment of the present invention; and

FIG. 19 is a flowchart of a method for estimating a base resistance of a thermal print head element for use in predicting a temperature of the thermal print head element according to one embodiment of the present invention.

### DETAILED DESCRIPTION

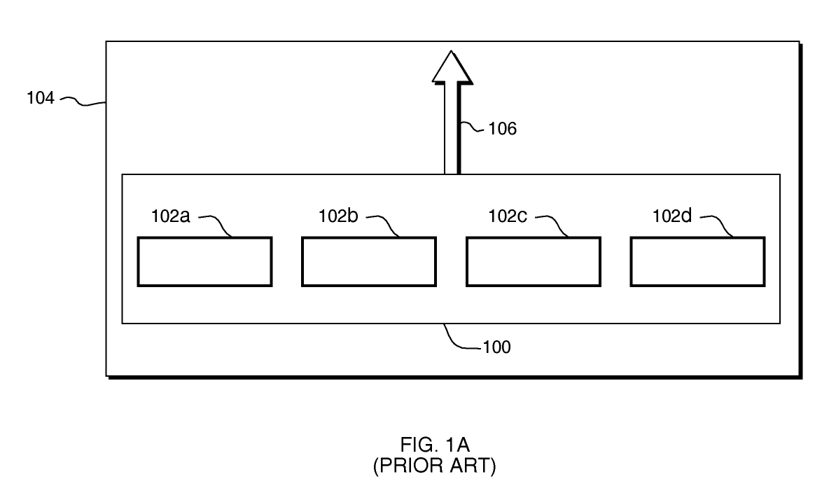

Before describing particular embodiments of the present invention, the operation of conventional thermal printers will be described by way of background. Referring to FIG. 1A, in a conventional bilevel thermal printer, a print head 100 includes a linear array of heating elements 102a-d (also referred to herein as “print head elements”). Although only four heating elements 102a-d are shown in FIG. 1A, it should be appreciated that a typical thermal print head includes a large number of small heating elements that are closely spaced at, for example, 300 elements per inch. Although the print head 100 in block diagram form in FIG. 1A is shown printing spots of a single color (such as black), thermal printers may have multicolor donor ribbons capable of printing spots of multiple colors. Furthermore, it should be appreciated that the heating elements 102a-d in the print head 100 may be of any shape and size, and may be spaced apart from each other at any appropriate distances and in any configuration.

The thermal print head 100 typically produces output on an output medium 104 (such as plain paper) as follows. For purposes of illustration, only a portion of the output medium 104 is shown in FIG. 1A. The output medium 104 moves underneath the print head 100 in the direction indicated by arrow 106. Delivering power to a particular print head element heats the print head element. When the element's temperature passes some critical temperature, it begins to transfer pigment (ink or wax) to the area of the output medium 104 that is currently passing underneath the heating element, creating what is referred to herein as a spot, or dot. The print head element will continue to transfer pigment to the output medium for as long as power is delivered to the print head element, and the temperature is above the critical temperature. A larger spot (or dot) may therefore be printed by delivering power to the print head element for a longer period of time. These larger spots are often referred to as “dots.”

A printer controller (not shown) inside the thermal printer is capable of selectively delivering power to any combination of the print head elements 102a-d at any particular time. Printer controllers in conventional thermal printers divide time into equal intervals of duration T_{c}, each of which is referred to herein as a “print head cycle.”

Referring to FIG. 1B, an example of a pattern of spots 108a-g printed by the print head 100 on the output medium 104 is shown. The output medium 104 is shown after the print head 100 has produced output for four print head cycles. Each of the rows 110a-d contain spots that were printed during a single one of the print head cycles. It should therefore be understood in general how a conventional thermal printer may produce desired patterns of spots on the output medium 104 by selectively activating thermal print head elements 102a-d during successive print head cycles. Note that although for ease of illustration the spots 108a-g in FIG. 1B are shown as solely growing in the vertical (down web) direction, in practice the spots 108a-g also grow in the horizontal (cross web) direction.

Having described prior art techniques for use by thermal printers, aspects of embodiments of the present invention will now be described. The resistivity of the material chosen for fabricating the heating elements 102a-d of the thermal print head (TPH) 100 typically exhibits some temperature dependence. This property has been used to actively control the heating element to maintain a desired temperature. Other applications include an offline calibration procedure to remove TPH-TPH variability, and estimation of the thermal model parameters for improved thermal history control.

All of these applications require the resistance-temperature mapping of the thermal print head element in its operating temperature range, which is much higher than the maximum allowable heat sink temperature. Techniques are disclosed herein for estimating this mapping based on measurements of thermal print head element resistance made over a limited range of TPH heat sink temperatures. Such estimation may use a model for predicting the TPH element temperature as a function of applied power in conjunction with a model for the resistance-temperature mapping. This model-based approach is capable of learning the functional relationship between the TPH element's resistance and its temperature for temperatures much higher than the maximum allowable heat sink temperature.

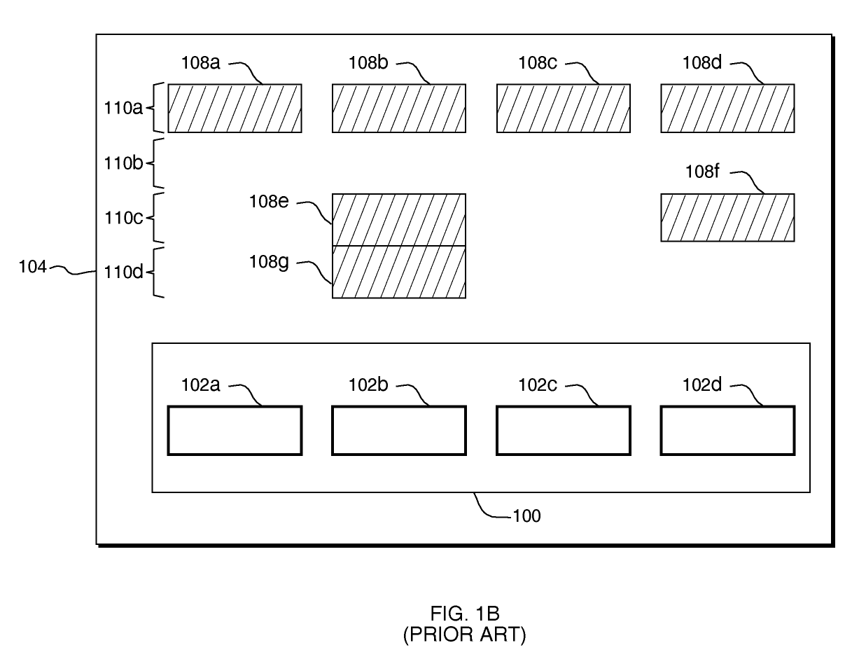

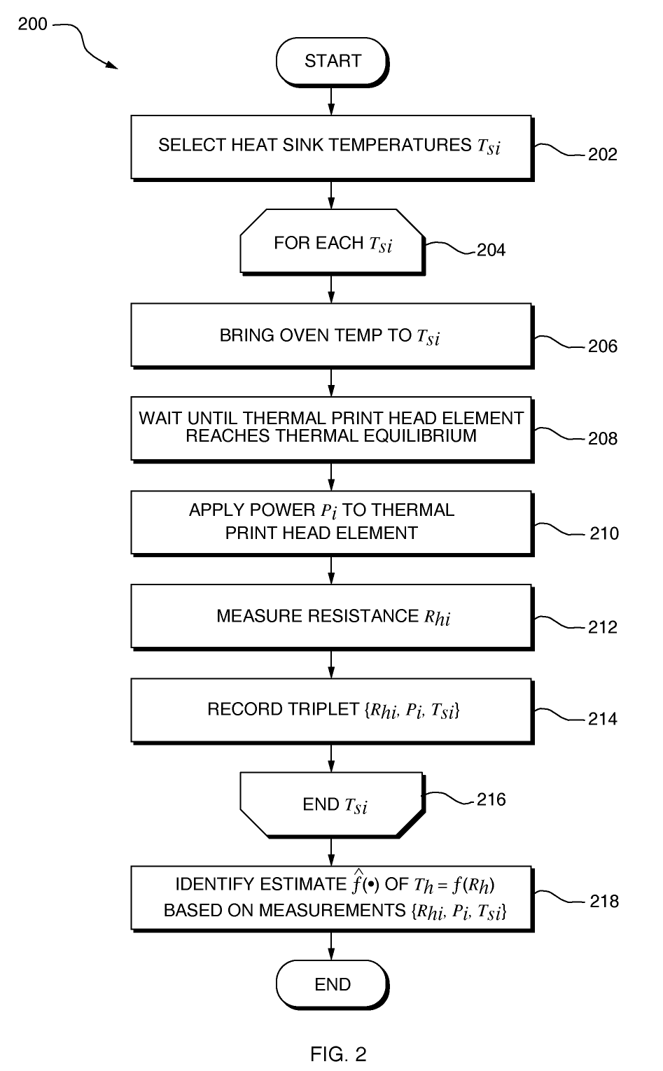

For example, referring to FIG. 2, a flowchart is shown of a method 200 that is performed according to one embodiment of the present invention to generate a resistance-temperature mapping for a particular thermal print head element in a thermal print head. A plurality of heat sink temperatures Tₛᵢ are selected, where i ranges from 1 to the number of measurements N (step 202). The thermal print head is placed in an oven or other heating mechanism which is relatively well-insulated against its surroundings, to ensure that the interior temperature is relatively uniform. The method 200 enters a loop over each of the heat sink temperatures Tₛᵢ (step 204). The oven is brought to temperature Tₛᵢ (step 206), and the thermal print head is allowed to reach thermal equilibrium (step 208). Power Pᵢ is applied to the thermal print head element for some predetermined time period (step 210). The value of Pᵢ may be constant across values of i or may vary. In general, it is desirable to select values of Pᵢ falling within the range of powers expected to be applied to the thermal print head element under normal operating conditions.

The resistance Rₕᵢ of the print head element is measured at the end of the predetermined time period (step 212). The resistance-power-temperature triplet (Rₕᵢ, Pᵢ, Tₛᵢ) is recorded (step 214). Steps 206-214 are repeated for the remaining heat sink temperatures (step 216). The same techniques may be applied to other print head elements in the print head to produce additional sets of measurement triplets.

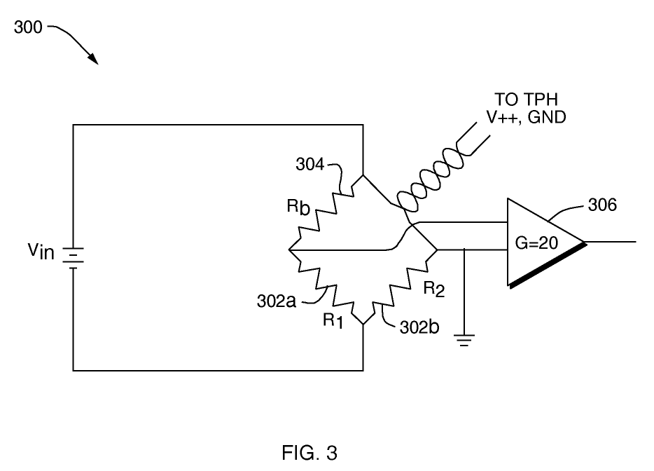

Referring to FIG. 3, a resistance measurement apparatus 300 is shown having a classical bridge configuration that may be used in one embodiment of the present invention to perform the resistance measurements described with respect to step 212 of FIG. 2. This is a classical bridge configuration. The resistors R₁ 302a and R₂ 302b are chosen to be small (≈10 Ω) to minimize any RC time-constant delays in the measurement system, and the resistor R_{b} 304 is chosen to approximately match the thermal TPH (TPH) resistance (to within ±100Ω). When current is turned on to an element of the print head, the currents in the two arms of the bridge 300 are nearly equal and the voltage sampled by the op-amp 306 (gain G=20) is nearly zero. Batteries supply all electrical power to the circuit 300 in order to minimize noise, and all supply voltages are regulated (not shown). The resistance values shown in FIG. 3 are merely for illustrative purposes and do not constitute limitations of the present invention.

The op-amp 306 is chosen to have a high gain-bandwidth product (>400 MHz), and low noise, to allow for high-speed measurements of the instantaneous resistance (the final system settling time is ≈0.5 μs). The op-amp's gain (G) and input offset (V_{off}) as well as the exact values of R₁ and R₂ are carefully calibrated using fixed, precision resistors in place of the thermal print head. To eliminate the effects of temperature drift on the resistors 302a-b and 304 and the op-amp 306, the entire circuit board is kept in an insulated box maintained at a constant temperature (±0.5 degrees C.).

The output of the op-amp (Vₒᵤₜ) is recorded on a digitizing oscilloscope for analysis. Also recorded is the input voltage Vᵢₙ. The instantaneous resistance is computed using Equation 1:

$${R}_{h} = \frac{{GR}_{2} {R}_{b} {V}_{i n} + {R}_{2} ( {R}_{1} + {R}_{b} ) ( {V}_{out} - {GV}_{off} )}{{GR}_{1} {V}_{i n} - ( {R}_{1} + {R}_{b} ) ( {V}_{out} - {GV}_{off} )} \qquad Equation 1$$

As described above with respect to FIG. 2, resistance measurements may be made for a variety of initial heat-sink temperatures Tₛᵢ of the print head after applying power for a predetermined duration of time (“on-time”). The final resistance measurement may be obtained by averaging the instantaneous resistance of Equation 1 over a short duration to reduce noise.

Let Tₕ=f(Rₕ) denote the unknown function that maps the resistance Rₕ of a print head element to its temperature Tₕ. The function f(·) is a characteristic of the material used to construct the print head elements. An estimate \hat{f}(·) of the function f(·) may be obtained based on the resistance, power, and temperature measurements {Rₕᵢ, Pᵢ, Tₛᵢ} described above (FIG. 2, step 218).

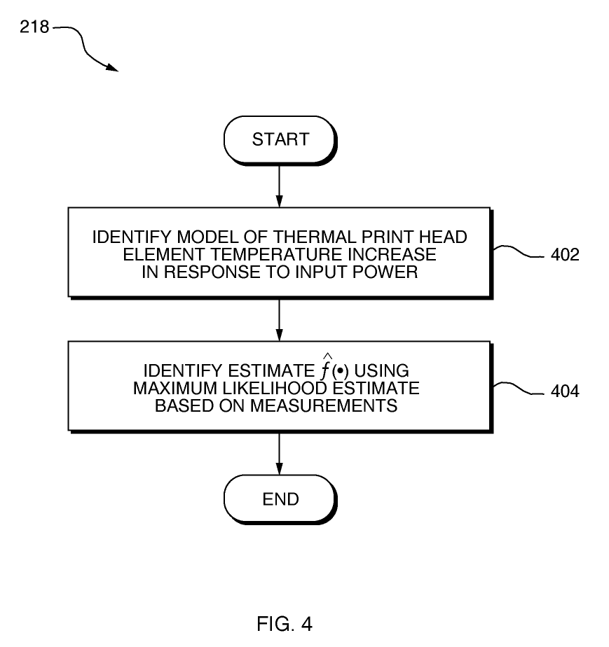

Examples of techniques for providing the estimate \hat{f}(·) will now be described in more detail. Referring to FIG. 4, a flowchart is shown of a method for implementing step 218 of FIG. 2, in which the estimate \hat{f}(·) is obtained.

As described above with respect to steps 206-208 of FIG. 2, the print head may be placed in a temperature-controlled environment and be allowed to come to thermal equilibrium with the surrounding before any measurements are made. This allows accurate measurement of the initial temperature of the heating elements before current is applied to them. However, in the process of measuring the resistance Rₕᵢ, some current has to be supplied to the print head element, thereby raising its temperature. Consequently, the temperature at which the resistance measurement is made is not known even though the initial temperature Tₛᵢ is known (since the heating element is allowed to come to thermal equilibrium). Therefore a model is needed of the increase in the temperature Tₕ of the thermal print head element, relative to the heat sink temperature Tₛ, in response to application of input power P for a predetermined duration. Such a model may be used to predict the temperature Tₕ of the print head element based on the (known) heat sink temperature Tₛ and the (known) input power P. Referring again to FIG. 4, a model of print head element temperature increase is identified (step 402). Such a model may be identified in any of a variety of ways, such as those described below.

First consider the case where the measurements are always made after the heating element is turned on for a fixed time interval. Input power

$$P = \frac{{V}_{i n}^{2} {R}_{h}}{{( {R}_{h} + {R}_{2} )}^{2}}$$

may be applied to the thermal print head element for a fixed duration. Although the applied power may actually vary during the heating element on-time because Rₕ varies as the heating element heats up, a typical thermal print head has a large Rₕ and a small

$$\frac{d {f}^{- 1} ( {T}_{h} )}{d {T}_{h}} .$$

As a result, the percent change in power during the on-time is negligible and may be ignored.

In the case where the input power P is applied for a fixed on-time, the rise in the temperature Tₕ of the heating element relative to the heat-sink temperature Tₛ is proportional to the input power P, as given by Equation 2. In Equation 2, A is a temperature model parameter that converts the applied power P to temperature.

Tₕ=Tₛ+AP, Equation 2

Equation 2 may be used to relate the resistance measurements Rₕ to the heat-sink temperatures Tₛ and applied power P, as given by Equation 3.

f(Rₕ)=Tₛ+AP Equation 3

Recall that the measurement triplet is denoted as {Rₕᵢ, Tₛᵢ, Pᵢ}, where the subscript i ranges from 1 to the number of measurements N. Using Equation 3 and assuming the measurements are corrupted by Gaussian noise, the estimate \hat{f}(·) may be obtained using a maximum likelihood estimator given by Equation 4 (FIG. 4, step 404) to produce estimates for the function f(·) and A.

$$[ \hat{f} ( \cdot ) , \hat{A} ] = {argmin}_{f ( \cdot ) , A} {\sum }_{i = 1}^{N} \frac{1}{{σ}_{i}^{2}} {( f ( {R}_{hi} ) - {T}_{si} - {AP}_{i} )}^{2} \qquad Equation 4$$

In Equation 4, σᵢ is the standard deviation of the noise on the print head element temperature arising from noise in the measurement triplet. In practice, the noise on the resistance measurements (σ_{R}) dominates and σᵢ may be approximated by Equation 5, in which f′(·) is the first derivative of f(Rₕᵢ) with respect to Rₕᵢ.

σᵢ=f′(Rₕᵢ)σ_{R} Equation 5

Therefore, in another embodiment, the estimate \hat{f}(·) may be obtained using a maximum likelihood estimator to produce estimates for the function f(·) and A by substituting Equation 5 into Equation 4, resulting in Equation 6 (FIG. 4, step 404).

$$[ \hat{f} ( \cdot ) , \hat{A} ] = {argmin}_{f ( \cdot ) , A} {\sum }_{i = 1}^{N} \frac{1}{{{f}^{′} ( {R}_{hi} )}^{2}} {( f ( {R}_{hi} ) - {T}_{si} - {AP}_{i} )}^{2} \qquad Equation 6$$

As described above, Equation 4 or Equation 6 may be used to provide the estimate \hat{f}(·) in step 218 of FIG. 2. Examples of techniques will now be described for formulating non-parametric models of f(·) to facilitate the optimization of Equation 4 and Equation 6.

Equation 7 illustrates a p^{th} order polynomial representation for f(·), where xⱼ, j=0, . . . , p are the polynomial coefficients.

f(R)=xₚRₕ^{p}xₚ₋₁Rₕ^{p-1}+ . . . +x₀, Equation 7

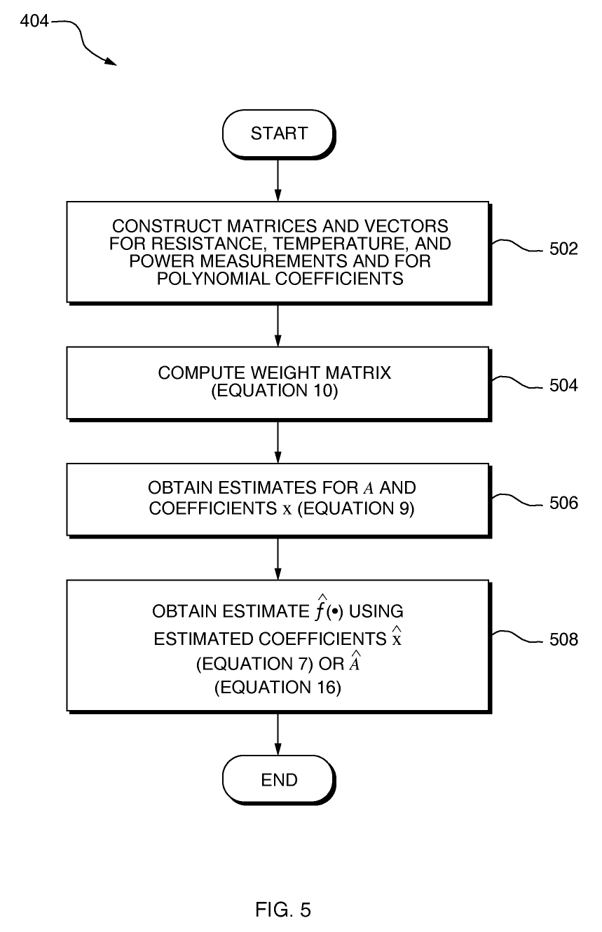

Equation 8 shows matrices and vectors (denoted by bold letters) that may be constructed from the measurements and unknown variables. Referring to FIG. 5, a flowchart is shown of a method that may be used to implement step 404 of FIG. 4 (estimation of f(·)) based on Equation 4. The method begins by constructing the matrices and vectors in Equation 8 (step 502).

$${R}_{h}^{p} = [ \begin{matrix}{R}_{h 1}^{p} & … & 1 \\ ⋮ & & ⋮ \\ {R}_{hN}^{p} & … & 1\end{matrix} ] , \\ {T}_{s} = [ \begin{matrix}{T}_{s 1} \\ ⋮ \\ {T}_{sN}\end{matrix} ] , \\ P = [ \begin{matrix}{P}_{1} \\ ⋮ \\ {P}_{N}\end{matrix} ] , \\ x = [ \begin{matrix}{x}_{p} \\ ⋮ \\ {x}_{0}\end{matrix} ] \qquad Equation 8$$

The solution to Equation 4 is given by Equation 9 (step 506), where W is a diagonal weight matrix defined by Equation 10 (step 504), and where D is a matrix defined by Equation 11. An estimate \hat{f}(·) is obtained using the estimated coefficients x and Equation 7 (step 508).

$$\begin{matrix}[ \begin{matrix}\hat{x} \\ \hat{A}\end{matrix} ] = {( {D}^{T} WD )}^{- 1} {D}^{T} {WT}_{s} & Equation 9 \\ W = [ \begin{matrix}1 / {σ}_{1}^{2} & & \\ & ⋱ & \\ & & 1 / {σ}_{N}^{2}\end{matrix} ] & Equation 10 \\ D = [ \begin{matrix}{R}_{h}^{p} & - P\end{matrix} ] . & Equation 11\end{matrix}$$

In one embodiment, Equation 6 is solved as follows. Note that in Equation 6 the weight matrix W depends on the derivative of a function that is being estimated. In one embodiment, Equation 6 is solved by estimating the parameters iteratively using Equation 9. At each iteration, the weight matrix is recomputed by Equation 12, using the function \hat{f}(·) estimated in the previous iteration.

$$W = [ \begin{matrix}1 / {{\hat{f}}^{′} ( {R}_{h 1} )}^{2} & & \\ & ⋱ & \\ & & 1 / {{\hat{f}}^{′} ( {R}_{hN} )}^{2}\end{matrix} ] \qquad Equation 12$$

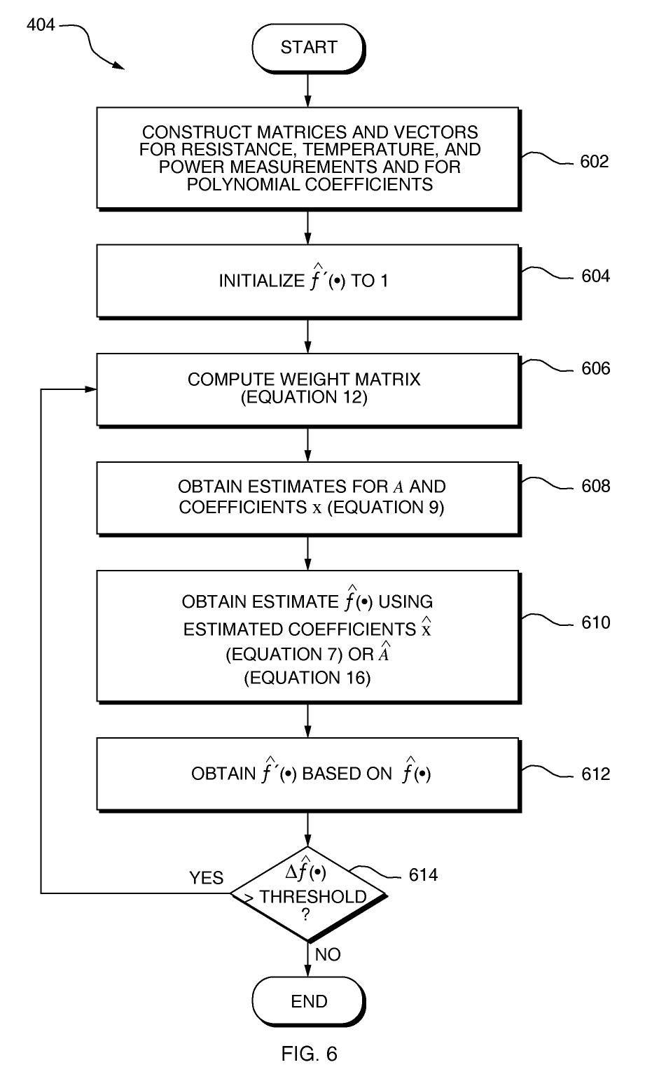

For example, referring to FIG. 6, a flowchart is shown of a method that may be used to implement step 404 of FIG. 4 (estimation of f(·)) based on Equation 6. The matrices and vectors are constructed in the same manner as described above with respect to step 502 of FIG. 5 (FIG. 6, step 602). An estimate \hat{f}′(·) of the derivative of f(·) is initialized to one (step 604). The weight matrix W is computed using Equation 12 based on the initial estimate \hat{f}′(·) (step 606). Estimates for \hat{x} and Â are obtained using Equation 9 (step 608). An estimate \hat{f}(·) is obtained using the estimated coefficients \hat{x} and Equation 7 (step 610). A new estimate \hat{f}′(·) is computed based on \hat{f}(·) (step 612).

Steps 606-612 may be repeated as many times as desired. For example, the current value of \hat{f}(·) may be compared to the value of \hat{f}(·) from the previous iteration of steps 606-612. If the difference is greater than some predetermined threshold value (step 614), steps 606-612 may be repeated. Otherwise, the method shown in FIG. 6 terminates. In this way, the estimate of \hat{f}(·) is refined until it converges on a final value to within the predetermined threshold tolerance.

It has been found that a global polynomial is not optimal in fitting local features of the function f(·). Increasing the order of the polynomial to improve the fit usually results in the numerical instability. Alternatively, a number of lower order polynomials may be fit locally. Typically, a piecewise linear approximation is sufficient. Examples of techniques for providing a piecewise polynomial (e.g., linear) approximation for f(·) will now be described.

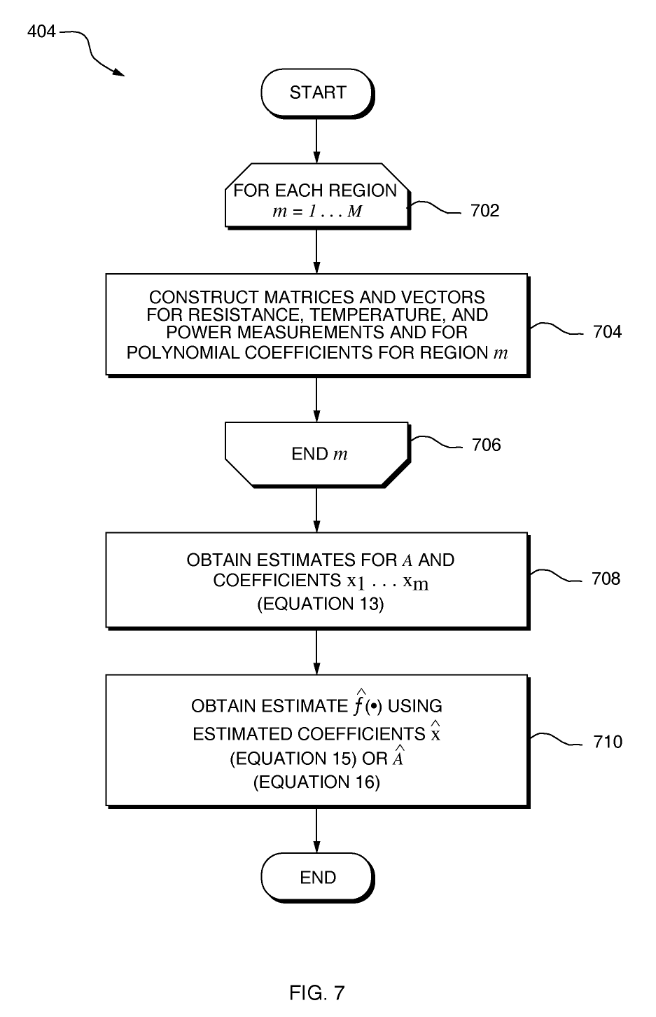

Let the domain of interest for the function f(·) be divided into M regions. Let m=I(Rₕ) denote the index of the region that Rₕ falls into. All the matrices and vectors defined in Equation 8 are now denoted with a subscript m. For example, the matrix Rₕₘ^{p} is constructed using only the resistance measurements Rₕᵢ such that I(Rₕ) is equal to m. Similarly, Pₘ and Tₛₘ contain all the power and heat-sink temperature measurements that corresponds to the resistance measurements in Rₕₘ^{p}. There are now M sets of polynomial coefficients, each denoted by the vector Xₘ. Referring to FIG. 7, a flowchart is shown of a method that may be used to implement step 404 of FIG. 4 (estimation of f(·)) based on Equation 4). The method constructs the matrices and vectors Rₕₘ^{p}, Tₛₘ, Pₘ, and xₘ for each region m (steps 702-706).

The method then obtains estimates for A and the coefficients x₁ . . . xₘ using Equation 13, which provides the solution to Equation 4 (step 708). An estimate \hat{f}(·) is obtained using the estimated coefficients \hat{x} and Equation 15 (step 710). In Equation 13, the matrix D is defined by Equation 14, and W is a diagonal weight matrix constructed as

$$W = [ \begin{matrix}{W}_{1} & & \\ & ⋱ & \\ & & {W}_{M}\end{matrix} ] ,$$

where Wₘ is computed from Equation 10 for the region m. The function \hat{f}(Rₕ) estimated by this method is given by Equation 15.

$$\begin{matrix}[ \begin{matrix}{\hat{x}}_{1} \\ ⋮ \\ {\hat{x}}_{M} \\ \hat{A}\end{matrix} ] = {( {D}^{T} WD )}^{- 1} {D}^{T} W [ \begin{matrix}{T}_{s 1} \\ ⋮ \\ {T}_{sM}\end{matrix} ] & Equation 13 \\ D = [ \begin{matrix}{R}_{h 1}^{p} & & & - {P}_{1} \\ & ⋱ & & ⋮ \\ & & {R}_{hM}^{p} & - {P}_{M}\end{matrix} ] & Equation 14 \\ \hat{f} ( {R}_{h} ) = {\hat{x}}_{I ( {R}_{h} ) p} {R}_{h}^{p} + … + {\hat{x}}_{I ( {R}_{h} ) 0} & Equation 15\end{matrix}$$

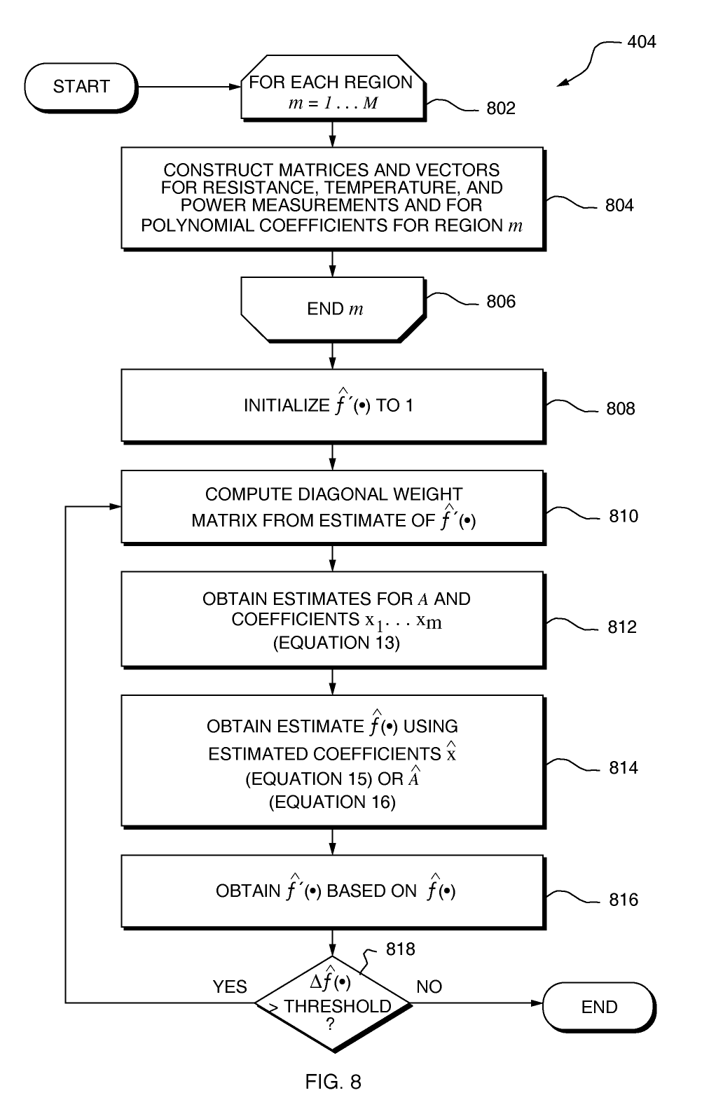

The iterative solution to Equation 6 may be performed in a fashion similar to that described above with respect to FIG. 6. More specifically, referring to FIG. 8, a flowchart is shown of a method that may be used to implement step 404 of FIG. 4 (estimation of f(·)) based on Equation 6. The matrices and vectors are constructed in the same manner as described above with respect to steps 702-706 of FIG. 7 (FIG. 8, steps 802-806).

An estimate \hat{f}′(·) of the derivative of f(·) is initialized to one (step 808). The diagonal weight matrix W is constructed as

$$W = [ \begin{matrix}{W}_{1} & & \\ & ⋱ & \\ & & {W}_{M}\end{matrix} ] ,$$

where Wₘ is computed using the estimate of \hat{f}′(·) (Equation 12) for the region m (step 810). Estimates for A and the coefficients x₁ . . . xₘ are obtained using Equation 13 (step 812). An estimate \hat{f}(·) is obtained using the estimated coefficients \hat{x}₁ . . . \hat{x}ₘ and Equation 15 (step 814). A new estimate \hat{f}′(·) is computed based on \hat{f}(·) (step 816).

Steps 810-816 may be repeated as many times as desired. For example, the current value of \hat{f}(·) may be compared to the value of \hat{f}(·) from the previous iteration of steps 810-816. If the difference is greater than some predetermined threshold value (step 818), steps 810-816 may be repeated. Otherwise, the method shown in FIG. 8 terminates. In this way, the estimate of \hat{f}(·) is refined until it converges on a final value to within the predetermined threshold tolerance.

The function estimated by this method will probably be discontinuous at the region boundaries because continuity constraints have not been imposed on the polynomial coefficients. It should be noted that the technique is not restricted to having non-overlapping regions. In the embodiment where the regions overlap, the estimated function is better behaved and has smaller discontinuities. In this case, a measurement has multiple region indices associated with it. Therefore a single measurement is replicated multiple times in the matrix D and the heat-sink temperature vector Tₛ.

The estimation of the temperature model parameter Â simplifies the optimization consideration posed in Equation 4. The preliminary piece-wise polynomial fit may be refined by fitting a spline to minimize the error metric given by Equation 16. This may be performed, for example, in step 508 in FIG. 5, step 610 in FIG. 6, step 710 in FIG. 7, or step 814 in FIG. 8.

$$\hat{f} ( \cdot ) = {argmin}_{f ( \cdot )} {\sum }_{i} \frac{1}{{σ}_{i}^{2}} {( f ( {R}_{hi} ) - {T}_{si} - \hat{A} {P}_{i} )}^{2} , \qquad Equation 16$$

Note that if Equation 16 is used to estimate \hat{f}(·), the estimated coefficients of the model \hat{x} are discarded and only Â is used.

A disadvantage of the piecewise polynomial approximation is that continuity between the different polynomial pieces estimated in Equation 13 is not guaranteed. The subsequent step given by Equation 16 of employing a spline to ensure continuity of \hat{f}(·) may be suboptimal as A is not jointly estimated in this step.

An optimal solution may be obtained by incorporating the continuity constraints directly in the joint estimation of A and f(·) by employing a spline model such as that described by M. Unser, “Splines-A perfect fit for signal and image processing,” IEEE Signal Proc. Magazine 16, pp. 22-38, November 1999, given by Equation 17, where Bₘ^{p}(·|kₘ, . . . , kₘ₊ₚ) is the m^{th} B-spline of order p for the knot sequence k₁≦k₂≦ . . . ≦k_{M+p}.

$$f ( {R}_{h} ) = {\sum }_{m = 1}^{M} {x}_{m} {B}_{m}^{p } ( {R}_{h} ) \qquad Equation 17$$

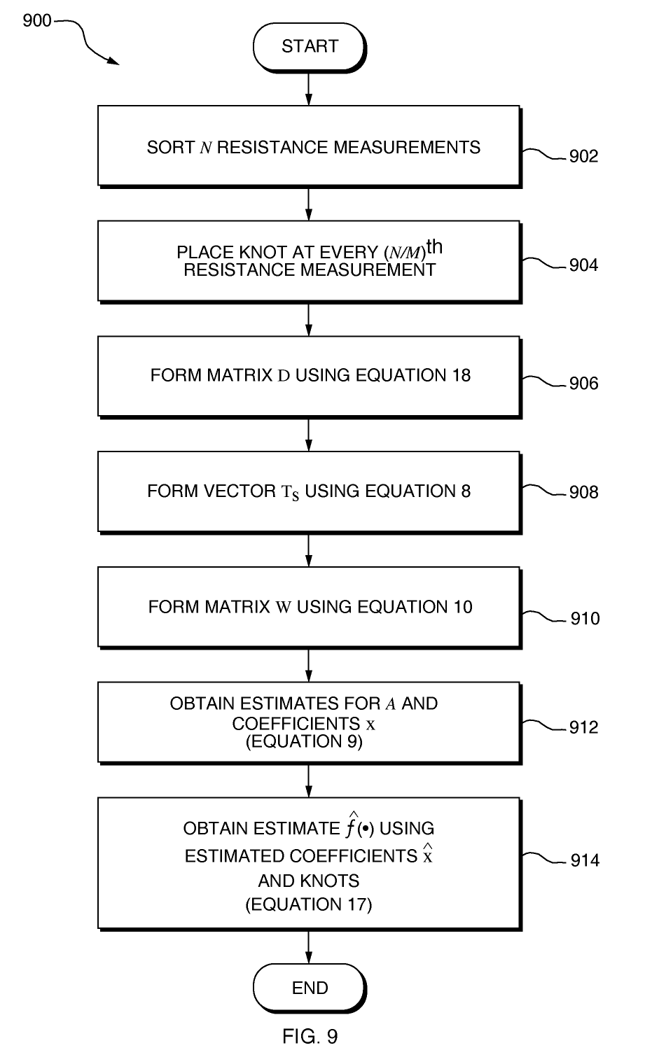

As shown by the method 900 of FIG. 9, the knot sequence may be chosen by sorting the N resistance measurements (step 902) and placing a knot at every (N/M)^{th} resistance measurement (step 904). This procedure non-uniformly places the knots and automatically yields more definition where a large number of measurements are clustered. The estimate \hat{f}(·) may then be obtained using Equation 17 (step 914) using estimates for A and x obtained using Equation 9 (step 912), except that D and x are instead defined by Equation 18 (step 906), W is defined by Equation 10 (step 908), and Tₛ is specified by Equation 8 (step 910).

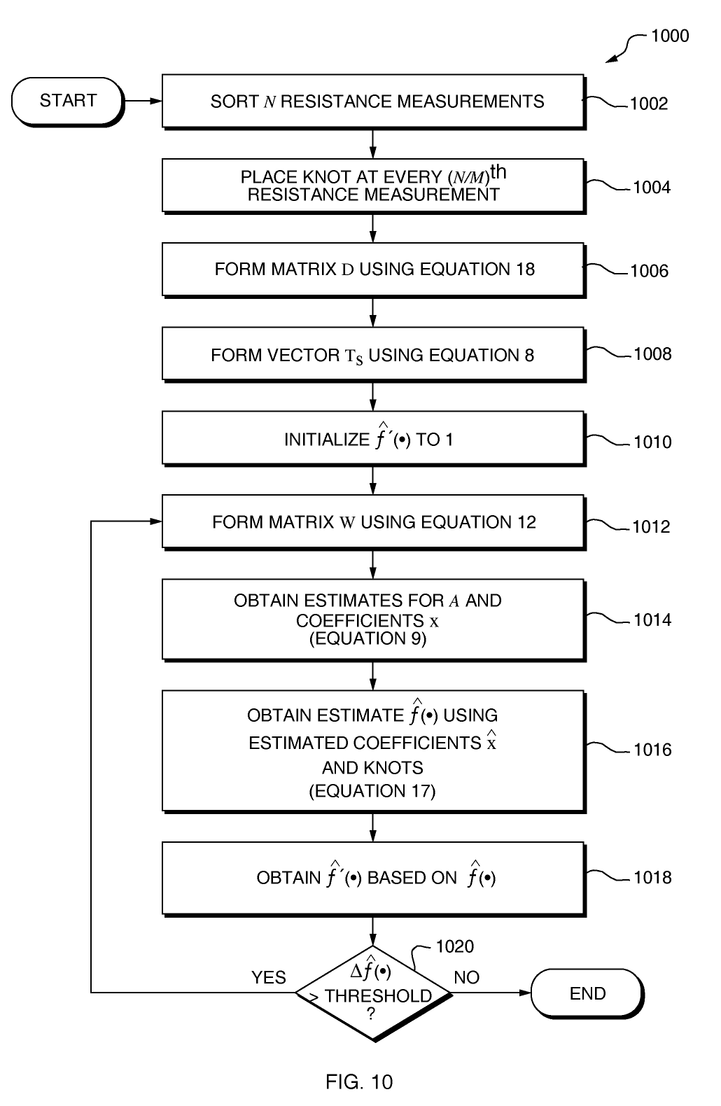

Referring to FIG. 10, an iterative version of the method 900 shown in FIG. 9 is illustrated. Steps 1002-1008 of method 1000 are performed in the same manner as steps 902-908 of the method 900 illustrated in FIG. 9. In step 1010, however, an estimate \hat{f}′(·) of the derivative of f(·) is initialized to one.

A loop is then entered in which the weight matrix W is constructed using Equation 12 (step 1012). Steps 1014 and 1016 are performed in the same manner as steps 912 and 914 of the method 900 illustrated in FIG. 9. A new estimate \hat{f}′(·) is computed based on \hat{f}(·) (step 1018). Note that the spline representation facilitates the computation of the derivative of fo for the weight matrix W in Equation 12 required for iterating the solution of Equation 9.

Steps 1012-1018 may be repeated as many times as desired. For example, the current value of \hat{f}(·) may be compared to the value of \hat{f}(·) from the previous iteration of steps 1012-1018. If the difference is greater than some predetermined threshold value (step 1020), steps 1012-1018 may be repeated. Otherwise, the method shown in FIG. 10 terminates. In this way, the estimate of \hat{f}(·) is refined until it converges on a final value to within the predetermined threshold tolerance.

$$D = ⌊ \begin{matrix}{B}_{1}^{p} ( {R}_{h 1} ) & … & {B}_{M}^{p} ( {R}_{h 1} ) & - {P}_{1} \\ ⋮ & ⋱ & ⋮ & ⋮ \\ {B}_{1}^{p} ( RN ) & … & {B}_{M}^{p} ( {R}_{hN} ) & - {P}_{N}\end{matrix} ⌋ , x = [ \begin{matrix}{x}_{1} \\ ⋮ \\ {x}_{M}\end{matrix} ] \qquad Equation 18$$

The joint estimation of f(·) and A tends to bias the temperature scale. The bias in the parameter estimates given by Equation 4 is difficult to compute directly since the estimated function \hat{f}(·) can take on an arbitrary shape. This can be simplified by assuming that our estimates of \hat{f}(·) and A differ from their true values by an unknown scalar s as given by Equation 19 and Equation 20. In Equation 20, T̅ₛ denotes the average heat-sink temperature in the measurements as given by Equation 21.

Â=sA Equation 19

\hat{f}(Rₕ)=s(f(Rₕ)− T̅ₛ)+ T̅ₛ Equation 20

$${\overline{T}}_{s} = \frac{1}{N} {\sum }_{i} {T}_{si} \qquad Equation 21$$

The maximum likelihood estimate for s is given by Equation 22, where ΔTₛᵢ=Tₛᵢ− T̅ₛ denote the variations of the heat-sink temperature measurements from the mean heat-sink temperature. The closed form expression for ŝ is obtained by setting the derivative with respect to s of the cost function that is being minimized in Equation 22 equal to zero, as given by Equation 23.

$$\begin{matrix}\hat{s} = {arg min}_{s} {\sum }_{i} \frac{1}{{σ}_{i}^{2}} {( s [ f ( {R}_{hi} ) - {\overline{T}}_{s} ] - Δ {T}_{si} - {sAP}_{i} )}^{2} , & Equation 22 \\ \hat{s} = \frac{{\sum }_{i} \frac{1}{{σ}_{i}^{2}} Δ {T}_{si} ( f ( {R}_{hi} ) - {\overline{T}}_{s} - {AP}_{i} )}{{\sum }_{i} \frac{1}{{σ}_{i}^{2}} {( f ( {R}_{hi} ) - {\overline{T}}_{s} - {AP}_{i} )}^{2}} , & Equation 23\end{matrix}$$

Let nᵢ, defined by Equation 24, denote the noise arising due to measurement noise in the triplet {Rₕᵢ, Tₛᵢ, P_{i}.}

nᵢ=f(Rₕᵢ)−Tₛᵢ−APᵢ Equation 24

Assume that E[nᵢ]=0 and E[nᵢ²]=σᵢ², where E[·]=0 is the expectation operator. Substituting Equation 24 into Equation 23 obtains Equation 25.

$$\begin{matrix}\hat{s} = \frac{{\sum }_{i} \frac{1}{{σ}_{i}^{2}} Δ {T}_{si} ( {n}_{i} + Δ {T}_{{s}_{{i}_{i}}} )}{{\sum }_{i} \frac{1}{{σ}_{i}^{2}} {( {n}_{i} + Δ {T}_{{s}_{i}} )}^{2}} \\ = \frac{1}{1 + \frac{1}{\frac{1}{N} {\sum }_{i} \frac{Δ {T}_{si}^{2}}{{σ}_{i}^{2}}}}\end{matrix} \qquad Equation 25$$

The last step in Equation 25 assumes the number of measurements N is large, such that

$${\sum }_{i} \frac{1}{{σ}_{i}^{2}} Δ {T}_{si} {n}_{i} \approx 0$$

and

$${\sum }_{i} \frac{{n}_{i}}{{σ}_{i}^{2}} \approx N .$$

We interpret the quantity SNR (Equation 26) as the average signal-to-noise ratio. The signal in this case is ΔTₛᵢ because it carries the primary source of information for the temperature model.

$$SNR ≡ \frac{1}{N} {\sum }_{i} \frac{Δ {T}_{si}^{2}}{{σ}_{i}^{2}} \qquad Equation 26$$

The expected value of Â is computed using Equation 25 as given by Equation 27. The bias in Â is given by Equation 28.

$$\begin{matrix}E [ \hat{A} ] = E [ \hat{s} ] A = \frac{A}{1 + \frac{1}{SNR}} & Equation 27 \\ E [ \hat{A} ] - A = \frac{- A}{1 + SNR} & Equation 28\end{matrix}$$

The result of Equation 28 implies that as SNR→∞, E[Â]→A and the bias in the estimated value of A disappears. Conversely, as the SNR decreases, the values of Â are increasingly biased lower. The reason for this phenomenon is directly related to the choice of the estimation criterion. As seen from Equation 4, A and f(·) are chosen such that the fitting error is minimized. The optimizer finds that it can lower the overall fitting error by choosing slightly lower values for A. This is because A amplifies the temperature, and by reducing the gain the fitting errors are reduced in magnitude. The amount by which the optimal value of A is lower than the true value depends on the spread of the heat-sink temperatures. For a large spread, any deviation from the true value results in a mismatch with the temperature model and drives up the fitting error. The biased parameters estimates are therefore accompanied by a biased estimate of the noise given by the fitting error. For small SNR s, the noise is underestimated as well. For example, in the extreme case of SNR=0, which occurs when ΔTₛᵢ=0, ∀i, the fitting error becomes 0 for Â=0 and \hat{f}(Rₕ)= T̅ₛ, ∀Rₕ.

Consider an alternative method of parameter estimation where the fitting error, instead of being minimized, is set equal to the expected noise. There are two problems with this alternative method. First, the amount of measurement noise may not be known. Second, even if the amount of measurement noise is known, the fitting error has an additional unknown component: the mismatch between the model for f(·) and the true f(·).

Given this uncertainty, in one embodiment, the bias in the estimated parameters is reduced by maximizing the average SNR as defined by Equation 26. In addition to minimizing the measurement noise variance, the variance of the heat-sink temperatures is maximized. Since the uniform distribution, among the class of uniform distributions, has the largest variance among all distributions, the maximum SNR for a given minimum and maximum heat-sink temperature is obtained by distributing the intermediate temperatures uniformly within the specified range.

All of the previous discussion has focused on a single on-time; i.e., the heating element is turned on for a fixed period of time at the end of which a single resistance measurement is taken. However, it may also be advantageous to make measurements using multiple on-times of varying duration. The reason is that for each distinct power measurement, it is desirable to wait for the thermal print head to come to thermal equilibrium to the control temperature before the measurement is made. These wait times can substantially increase the data acquisition time. On the other hand, the measurements for distinct on-times may be taken in one run; the heating element in this case is turned on and left in that state for the longest on-time that is desired. In step 212 of the method 200 shown in FIG. 2, instead of measuring a single resistance Rₕᵢ, a resistance is measured and recorded at discrete time instances corresponding to all of the desired on-times. If the longest on-time is short enough, the temperature rise for a Δt on-time can be accurately modeled by a single time constant τ as given by Equation 29.

$${T}_{h} = {T}_{s} + A ( 1 - {e}^{- \frac{Δ t}{τ}} ) P \qquad Equation 29$$

This increases the number of parameters to estimate by one as τ is now an additional unknown. Since the temperature model depends non-linearly on the time constant τ, a closed form solution to Equation 4 is no longer possible. However, Equation 29 may be linearized by performing a first order Taylor series expansion about the current estimate of τ (τ₀), as shown in Equation 30.

$$1 - {e}^{- \frac{Δ t}{τ}} \approx 1 - {e}^{- \frac{Δ t}{{τ}_{0}}} - \frac{τ - {τ}_{0}}{{τ}_{0}^{2}} {e}^{- \frac{Δ t}{{τ}_{0}}} \qquad Equation 30$$

Rewriting Equation 29 with the approximation of Equation 30 gives Equation 31.

$${T}_{h} \approx {T}_{s} + A ( 1 - {e}^{- \frac{Δ t}{{τ}_{0}}} + \frac{{e}^{- \frac{Δ t}{{τ}_{0}}}}{{τ}_{0}} ) P - A τ \frac{{e}^{- \frac{Δ t}{{τ}_{0}}}}{{τ}_{0}^{2}} P \qquad Equation 31$$

If we let B=Aτ, then the solution to the global polynomial method is given by Equation 32, where D is given by Equation 33 and the vectors P_{A} and P_{B} are given by Equation 34.

$$\begin{matrix}⌊ \begin{matrix}\hat{x} \\ \hat{A} \\ \hat{B}\end{matrix} ⌋ = {( {D}^{T} WD )}^{- 1} {D}^{T} {WT}_{s} & Equation 32 \\ D = [ \begin{matrix}R & - {P}_{A} & {P}_{B}\end{matrix} ] & Equation 33 \\ {P}_{A} = ⌊ \begin{matrix}\begin{matrix}( 1 - {e}^{- \frac{Δ {t}_{1}}{{τ}_{0}}} + \frac{{e}^{- \frac{Δ {t}_{1}}{{τ}_{0}}}}{{τ}_{0}} ) {P}_{1} \\ ⋮\end{matrix} \\ ( 1 - {e}^{- \frac{Δ {t}_{N}}{{τ}_{0}}} + \frac{{e}^{- \frac{Δ {t}_{N}}{{τ}_{0}}}}{{τ}_{0}} ) {P}_{N}\end{matrix} ⌋ , \\ {P}_{B} = [ \begin{matrix}\frac{{e}^{- \frac{Δ {t}_{1}}{{τ}_{0}}}}{{τ}_{0}^{2}} {P}_{1} \\ ⋮ \\ \frac{{e}^{- \frac{Δ {t}_{N}}{{τ}_{0}}}}{{τ}_{0}^{2}} {P}_{N}\end{matrix} ] & Equation 34\end{matrix}$$

Note that Δtᵢ denotes the time power Pᵢ is applied to the print head element. The weight matrix W (Equation 10) and vector Tₛ (Equation 8) are the same as defined for the global polynomial method.

An updated value of the time constant is obtained as given by Equation 35. The procedure may be iterated by recomputing the vectors P_{A} and P_{B} for the new value of τ until the estimates converge.

$$τ = \frac{\hat{B}}{\hat{A}} \qquad Equation 35$$

The iterative version of the global polynomial method as well as the solution to the piece-wise polynomial and the spline method follows along the same lines as presented above and should be straightforward for someone having ordinary skill in the art to derive.

Now consider the case when the on-times Δt are very short compared to the time constant τ of the print head. Therefore, Δt/τ is small. As a result, 1−e^{-Δt/τ} may be approximated by Δt/τ. In this case, Equation 29 is equivalent to Equation 2, with A/τ substituted for A, and with PΔt substituted for P. Therefore, Equation 29 may be solved by using the techniques applied above to Equation 2, but with a new variable B=A/τ substituted for A, and with PΔt substituted for P.

Another alternative is to employ a different value of A for each of the different on-times. The temperature model is then given by Equation 36.

Tₕ=Tₛ+A_{Δt}P. Equation 36

Since the model is linear in the different A_{Δt} parameters, the solutions presented above with respect to Equation 7—Equation 18 are directly applicable with only minor modifications, which will be apparent to those having ordinary skill in the art. For a limited number of on-times, the increase in the number of parameters is modest as compared to the model of Equation 29.

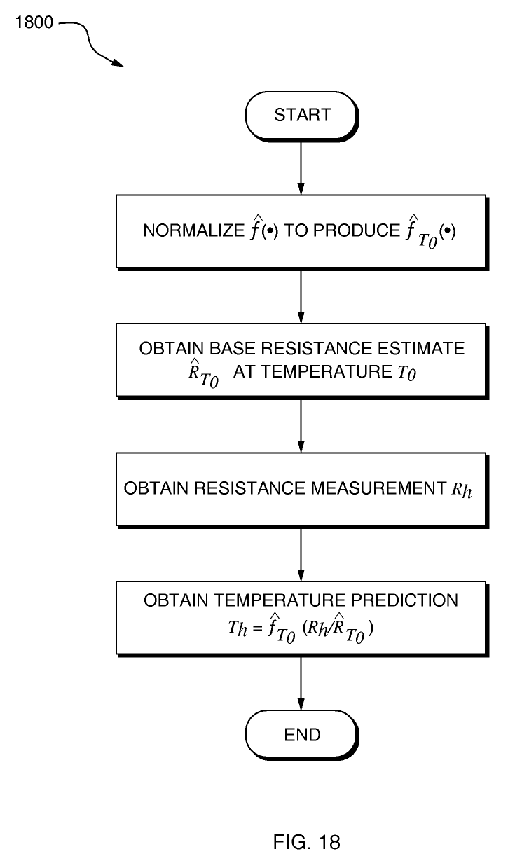

Having described various techniques for producing the estimate \hat{f}(·), examples of techniques will now be described for using the estimate \hat{f}(·), with reference to the method 1800 of FIG. 18. Recall that the estimate \hat{f}(·) for a particular print head element relates the absolute resistance of the element to its absolute temperature. Therefore, \hat{f}(·) is not generally applicable to other print head elements that have a different base resistance (defined as the resistance of the element at some predetermined fixed temperature). If, however, the print head element for which \hat{f}(·) was generated is made from the same material as another print head element, the relative change in the resistances of the two print head elements with respect to their base resistances will be the same for a unit change in temperature.

Therefore, in one embodiment we define \hat{f}_{T}_{₀}), which is a normalized version of \hat{f}(·) (step 1802). R_{T}_{₀} is the print head element resistance at temperature T₀. \hat{f}_{T}_{₀} may be used to estimate the temperature of any print head element made from the same material as the print head element used to estimate \hat{f}(·), as follows.

An estimate \hat{R}_{T}_{₀} is obtained of the base resistance of the print head element at temperature T₀ (step 1804). The current resistance Rₕ of the print head element is measured (step 1806), and the temperature Tₕ of the print head element is estimated using Tₕ=\hat{f}_{T}_{₀}(Rₕ/\hat{R}_{T}_{₀}) (step 1808).

Measurement of the base resistance \hat{R}_{T}_{₀}, however, poses a problem. Typically, the print head is kept in an oven at temperature T₀ and a small amount of current is applied to the element to measure its resistance \hat{R}_{T}_{₀}. If the current applied is very small, there will be no appreciable rise in the element's temperature from the equilibrium temperature T₀ and the estimate will be reasonably accurate.

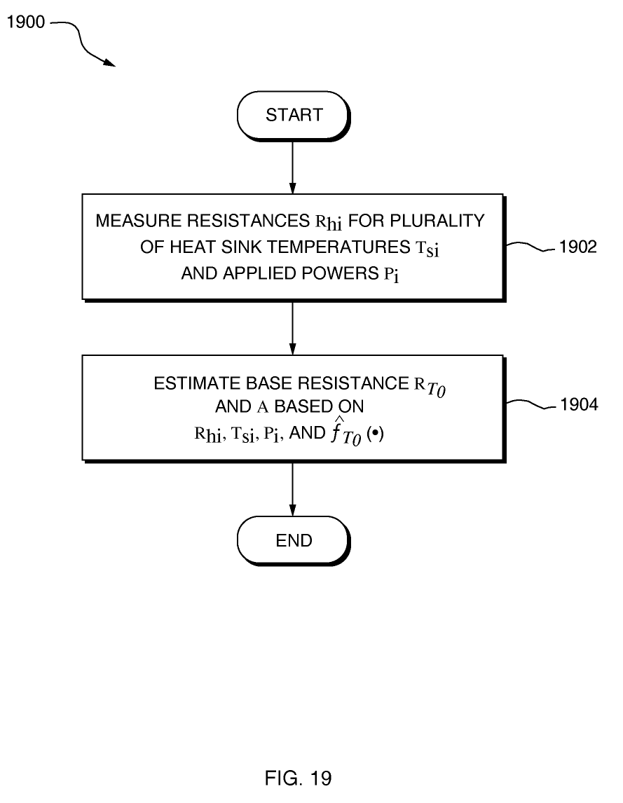

If, however, the current is not small or if more accuracy is desired, the method 1900 illustrated in FIG. 19 may be used. The resistance Rₕᵢ of the print head element is measured for various combinations of heat sink temperatures Tₛᵢ and applied powers Pᵢ, where i ranges from 1 to N, and wherein N≧2 (step 1902). The base resistance \hat{R}_{T}_{₀} and A are estimated simultaneously (step 1904). \hat{R}_{T}_{₀} and A may, for example, be estimated simultaneously using Equation 37.

$$[ {\hat{R}}_{{T}_{0}} , \hat{A} ] = arg {min}_{{R}_{{T}_{0}} , A} {\sum }_{i = 1}^{N} {( {\hat{f}}_{{T}_{0}} ( {R}_{hi} / {R}_{{T}_{0}} ) - {T}_{si} - {AP}_{i} )}^{2} \qquad Equation 37$$

If, however, \hat{R}_{T}_{₀} is known or estimated independently as described above, A may be estimated using Equation 38, in which case \hat{R}_{T}_{₀} need not be estimated in step 1904.

$$\hat{A} = \frac{{\sum }_{i = 1}^{N} {P}_{i} ( {\hat{f}}_{{T}_{0}} ( {R}_{hi} / {\hat{R}}_{{T}_{0}} ) - {T}_{si} )}{{\sum }_{i = 1}^{N} {P}_{i}^{2}} \qquad Equation 38$$

The techniques disclosed above may be used to eliminate or reduce print head element to print head element variability, or print head to print head variability. For example, an estimate of A may be obtained for a first print head element, and a separate estimate of A may be obtained for a second print head element. The input energy provided to the first and second print head elements may be adjusted based on a function of the first and second estimates to reduce or eliminate variability between the print head elements. For example, the energies may be adjusted based on a ratio of the first and second estimates.

Similarly, a first plurality of estimates of A may be obtained for a first plurality of print head elements. The first plurality of estimates may be averaged to obtain a first estimate of A. A second plurality of estimates of A may be obtained for a second plurality of print head elements. The second plurality of estimates may be averaged to obtain a second estimate of A. The input energy provided to the first thermal print head element and the input energy provided to the second thermal print head element may be adjusted based on a function of the first and second averages to reduce or eliminate variability between the print head elements. In either case, the energy may, for example, be adjusted by adjusting the input power and/or the on-time of the thermal print head elements. Those having ordinary skill in the art will appreciate how to apply similar techniques to reduce or eliminate variability between print heads rather than print head elements.

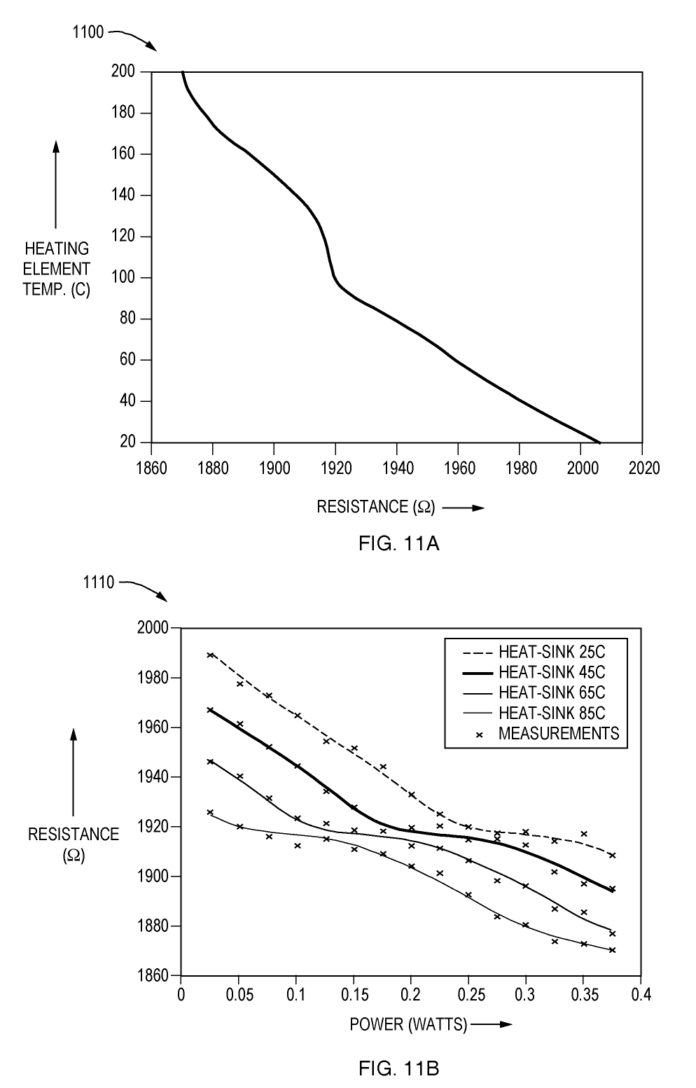

Consider first a synthetic example in which we have access to the true model parameters, so that we can assess the estimation accuracy of the different techniques disclosed herein. FIG. 11A shows the ground truth temperature vs. resistance function for the heating element that is used to generate the synthetic data. FIG. 11B shows the resistance measurements made at different heat-sink temperatures and applied powers. We used the temperature model of Equation 2 with A=300 C./Watts and f(·) as in FIG. 11A to compute the true resistance of the heating elements. The measurements are shown as “crosses” taken at 15 different power levels and 4 different heat-sink temperatures. Gaussian noise of standard deviation 2Ω was added to the true resistance to obtain the final measurements. No noise was added to the measurements of power and heat-sink temperature. The average SNR for this data set is 21.1. From Equation 27, we obtain E[Â]=286.42 (a bias of 13.57 C./Watts in A) if the shape of the estimated function is the same as the ground truth.

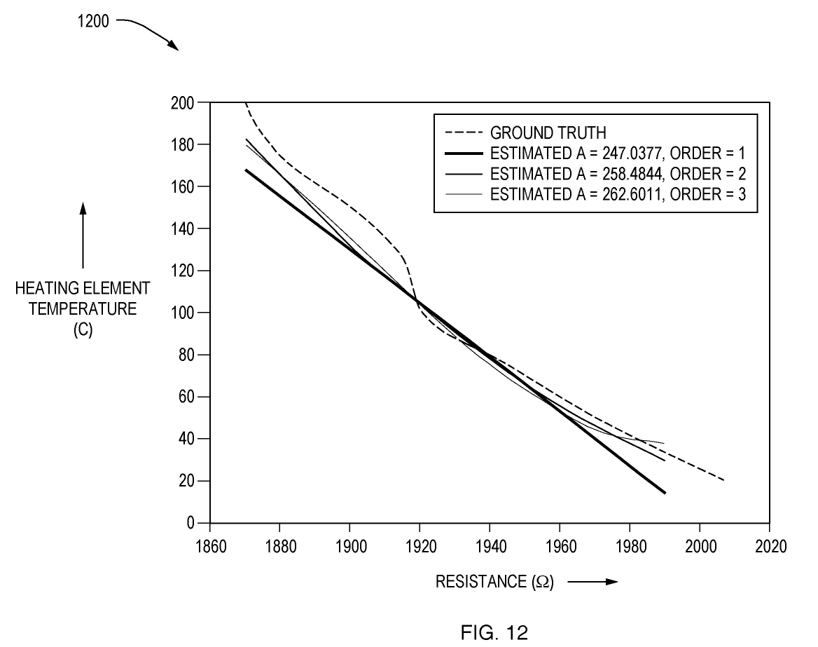

FIG. 12 shows the estimated function \hat{f}(·), using different order polynomials according to Equation 7. A single iteration of Equation 9 was performed with the weight matrix W set to identity (i.e., the noise was assumed to be identically distributed for all samples). We did not iterate on the solution by computing a new weighting matrix based on the derivative of the estimated function. As shown in FIG. 12, the polynomial model is not a very good fit to the local features of the ground truth function and as such the estimate is not very accurate even for high order polynomials. Furthermore, the estimate of A is biased lower from the true value of 300 in all the cases, although the bias decreases somewhat for the higher order polynomials.

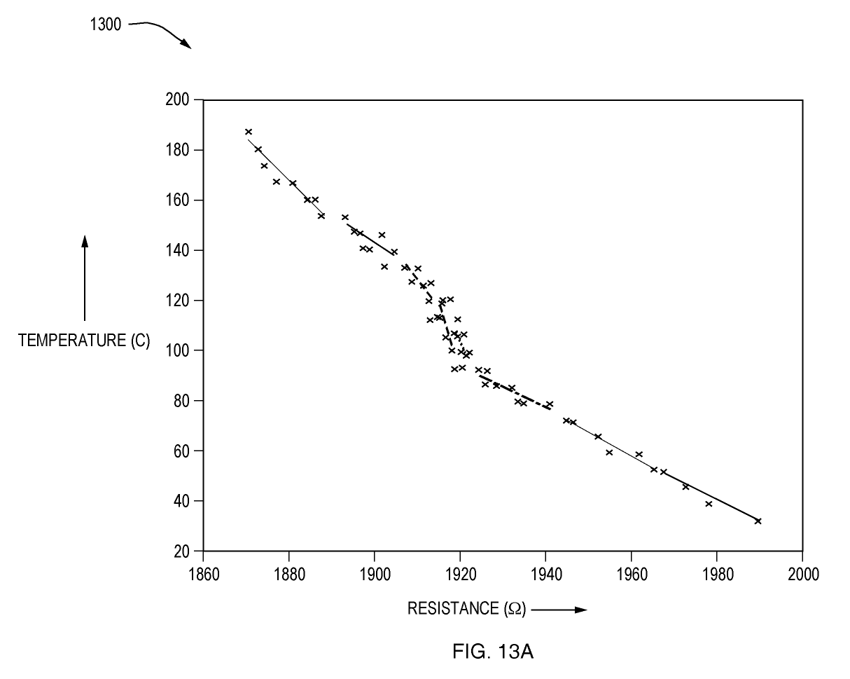

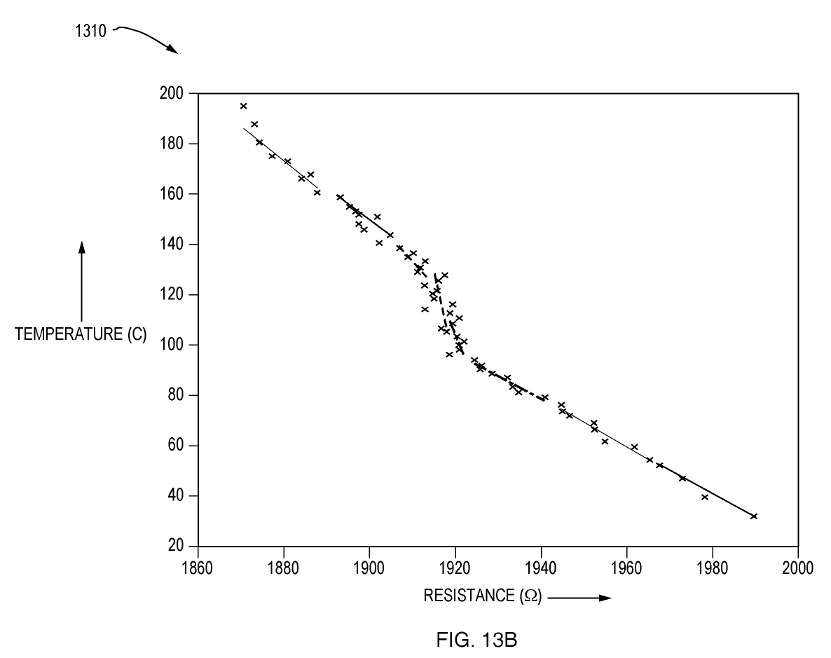

FIG. 13 shows the results obtained for the techniques described above with respect to Equation 13-Equation 16, for the synthetic data of FIG. 11. Eight non-overlapping regions were chosen such that each region had the same number of samples. Choosing the regions in this manner has the advantage that it automatically provides more definition or a higher resolution estimate for the unknown function in regions where there are more resistance measurements. A first order polynomial is chosen to fit the data in each of the regions. FIG. 13A shows the estimated function after the first iteration in which we assumed the weighting matrix W to be identity. FIG. 13B shows the result after the second iteration in which the weighting matrix is chosen as in Equation 12 based on the derivative of the function estimated in FIG. 13A.

In the first iteration of the solution given by Equation 13 (shown in FIG. 13A), the weight matrix W is set to identity since we do not have an initial estimate of f(·). In this case, A is estimated to be 273.56, which is biased quite a bit lower than the true value of 300. With this value of Â, a second order spline is fitted to the data using Equation 16. The derivative of this spline fit is used to obtain a new weight matrix W , which is used again in Equation 13 to obtain the estimate shown in FIG. 13B. It is seen that the local high slope region is better approximated by the fit in FIG. 13B as compared to FIG. 13A. Previously, the optimizer was reluctant to increase the slope of the fit in the high slope region as this would have increased the noise considerably in this region as compared to the rest of the curve. However, the new weight matrix selectively deemphasizes the noise in this region and allows the optimizer to increase the slope of the fit to accurately reproduce the local feature. The bias in the estimated value of Â=294.34 is also reduced, which is now much closer to the true value of 300.

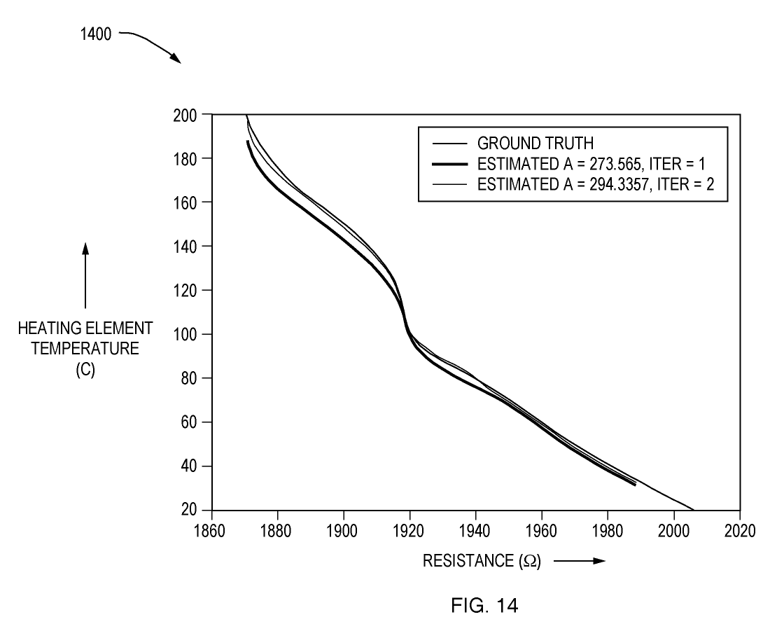

FIG. 14 compares the spline fits obtained in iterations 1 and 2 to the ground truth when the spline is used as a post-process correction, as described above with respect to Equation 16. Once the value of A is estimated, the thermal model of Equation 2 is utilized to associate a temperature with each measured resistance. A second order spline is then fitted to the resistance temperature pairs to obtain the final estimate. It is seen that the estimate obtained after the second iteration of the piece-wise linear fit is very accurate and the bias in A of 5.66 C./Watts is lower than the estimated bias of 13.57.

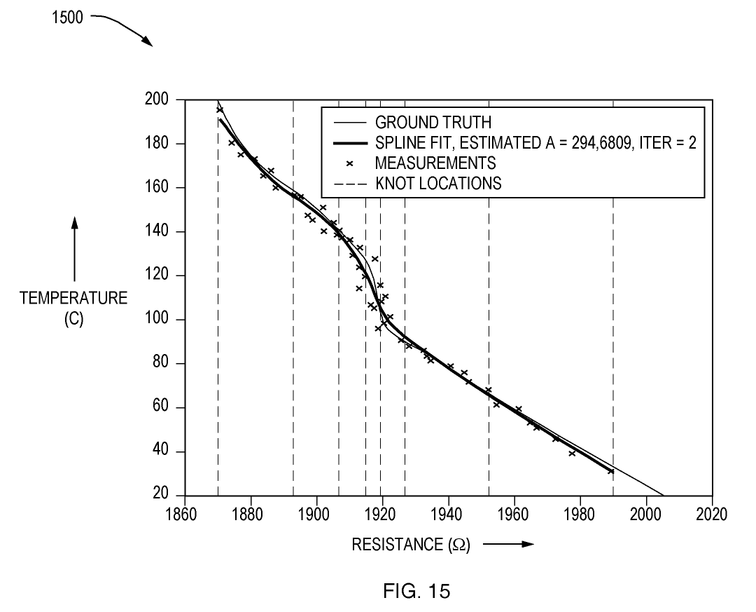

FIG. 15 shows the estimated resistance vs. temperature function for the spline model described above with respect to Equation 17-Equation 18. A second order spline with 8 knots was employed for the fit to enable direct comparison to the estimate obtained using the piece-wise polynomial method shown in FIG. 14. The eight knots were chosen by sorting the measurements and picking out every (N/8)^{th} sample. The knot locations determined from the measurements are shown as vertical dashed lines. It is seen that more knots are automatically placed in regions where the resistance measurements are clustered. The estimated Â=294.68 is slightly closer to the ground truth value of 300 than the value obtained using the piece-wise polynomial method.

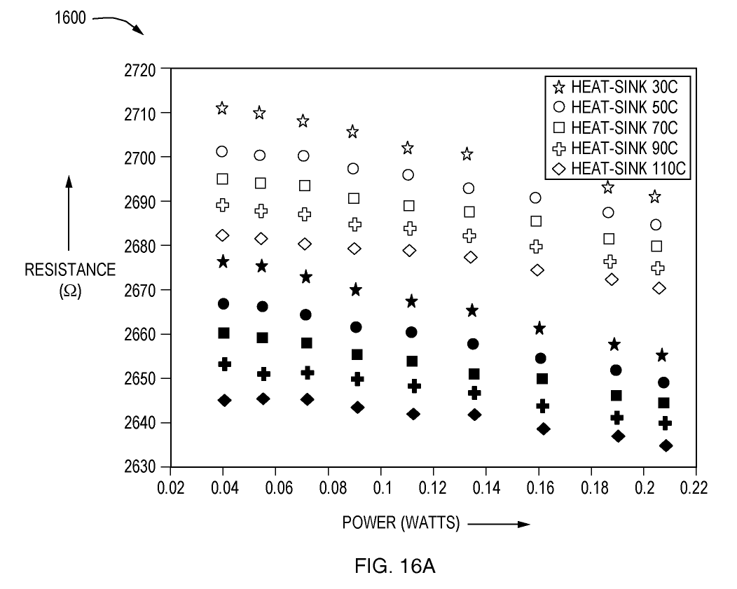

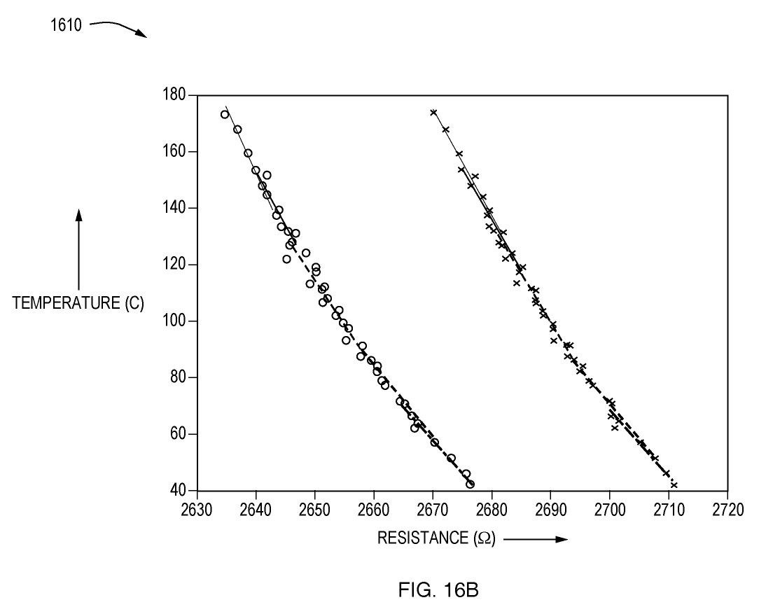

FIG. 16A shows the data collected on a Toshiba thermal print head with 9 different power levels and 5 different heat-sink temperatures. The true values of A, f(·), and the noise standard deviation τᵢ are not known for this data set. The “crosses” and “circles” correspond to two different heating elements that are 64 elements apart. FIG. 16B shows the fits for the two heating elements using the piece-wise linear model for f(·). Four regions were chosen by sorting and separating the measured resistances into four groups. There was a 75% overlap between the regions. The estimated A for the two elements are Â₁=310.05 and Â₆₄=305.44. The estimated average temperature noise

$$\sqrt{\frac{1}{N} {\sum }_{i} {σ}_{i}^{2}}$$

was approximately 2.5° C. The gives an SNR of approximately 130 and a bias of 1% in Â.

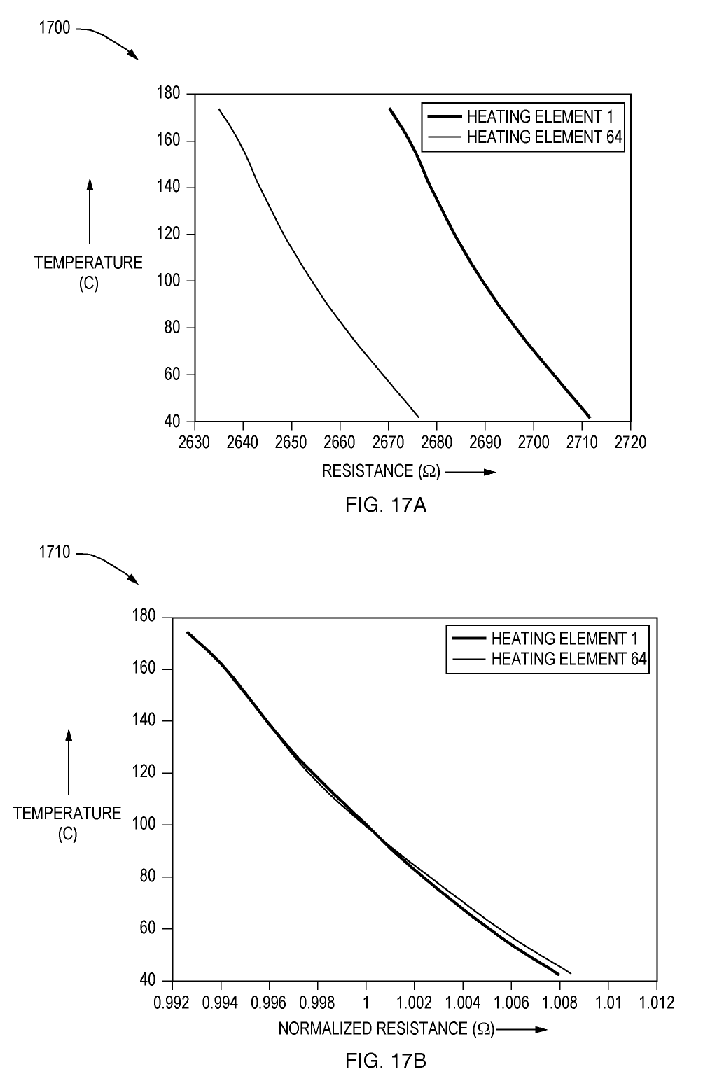

FIG. 17A shows a second order spline fit to resistance and reconstructed temperature sample pairs of FIG. 16B. We see that these functions differ on the predicted temperature based on the absolute measured resistance. However, if the material properties are the same for the heating elements 1 and 64, the functions should agree on the change in resistance for a unit change in temperature. FIG. 17B shows \hat{f}(·) as a function of normalized resistance where 100° C. is chosen as the normalization point. It is seen that there is good agreement between the two estimates and the differences are on the order of the noise.

It has been shown that the simultaneous estimation of the temperature scale and resistance-temperature mapping is biased for the MLE. The bias may be reduced by lowering the measurement noise and/or increasing the range of the heat-sink temperatures for the resistance measurements. The piece-wise polynomial or the spline method may be used to reduce the model mismatch and bias since it can conform to any local feature of the resistance-temperature mapping. The model-based approach successfully estimates this mapping for temperatures much higher than the maximum heat-sink temperature used in the measurements.

A parametric model for the resistance change with temperature derived from the underlying physics of semiconductors (N. W. Ashcroft and N. D. Mermin, Solid State Physics, Saunders College Publishing, 1976) may be used for f(·). If the model accurately describes the heating elements material characteristics, it has the advantage of reducing the number of parameters that need to be estimated. Consequently, fewer measurements will be required to achieve the same accuracy as that of the non-parametric methods.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) identifying a first plurality of estimates of a parameter A for a first plurality of print head elements in a first thermal print head, wherein the equation Tₕ=Tₛ+AP relates thermal print head element temperature Tₕ to a heat sink temperature Tₛ and input power P;
(B) identifying a first average value of the first plurality of estimates;
(C) identifying a second plurality of estimates of the parameter A for a second plurality of print head elements in a second thermal print head;
(D) identifying a second average value of the second plurality of estimates; and
(E) adjusting a first input energy provided to the first thermal print head and a second input energy provided to the second thermal print head based on a function of the first average value and the second average value.

2. The method of claim 1, wherein (E) comprises adjusting a first input power provided to the first thermal print head and a second input power provided to the second thermal print head based on the function of the first average value and the second average value.

3. The method of claim 1, wherein (E) comprises adjusting a first on-time of the first thermal print head and a second on-time of the second thermal print head based on the function of the first average value and the second average value.

4. A computer-implemented method comprising:
(A) identifying a first estimate of a parameter A for a first print head element in a first thermal print head, wherein the equation Tₕ=Tₛ+AP relates thermal print head element temperature Tₕ to a heat sink temperature Tₛ and input power P;
(B) identifying a second estimate of the parameter A for a second print head element in the first thermal print head; and
(C) adjusting a first input energy provided to the first thermal print head element and a second input energy provided to the second thermal print head element based on a function of the first estimate and the second estimate.

5. The method of claim 4, wherein (A) comprises:
(A)(1) identifying a first plurality of estimates of the parameter A for a first plurality of print head elements in the first thermal print head, the first plurality of print head elements including the first print head element, the first plurality of estimates including the first estimate; and
(A)(2) identifying a first average value of the first plurality of estimates;
wherein (B) comprises:
(B)(1) identifying a second plurality of estimates of the parameter A for a second plurality of print head elements in the first thermal print head, the second plurality of print head elements including the second print head element, the second plurality of estimates including the second estimate; and
(B)(2) identifying a second average value of the second plurality of estimates; and
wherein (C) comprises adjusting the first input energy provided to the first thermal print head element and the second input energy provided to the second thermal print head element based on a function of the first average value and the second average value.

6. The method of claim 4, wherein (E) comprises adjusting a first input power provided to the first thermal print head element and a second input power provided to the second thermal print head element based on the function of the first average value and the second average value.

7. The method of claim 4, wherein (E) comprises adjusting a first on-time of the first thermal print head element and a second on-time of the second thermal print head element based on the function of the first average value and the second average value.

8. A thermal print head resistance measurement apparatus comprising a bridge circuit including a constant voltage input, an operational amplifier, and four resistors, wherein one of the resistors comprises a thermal print head element.

9. A computer-implemented method for estimating a temperature Tₕ of a print head element in a thermal print head, the method comprising:
(A) identifying an estimate of a function Tₕ=f(Rₕ) relating print head element resistance Rₕ to print head element temperature Tₕ;
(B) identifying a resistance Rₕ of the print head element; and
(C) estimating the temperature Tₕ of the print head element based on the estimate \hat{f}(·) and the resistance Rₕ.

10. The method of claim 9, wherein (C) comprises:
(C)(1) normalizing the domain of the estimate \hat{f}(·) at a temperature T₀ to produce a normalized estimate \hat{f}_{T}_{₀}(·); and (C)(2) estimating the temperature Tₕ based on the normalized estimate \hat{f}_{T}_{₀}(·) and the resistance Rₕ.

11. The method of claim 10, wherein (C) further comprises:
(C)(3) obtaining a base resistance estimate \hat{R}_{T}_{₀} of the print head element at the temperature T₀; and
wherein (C)(2) comprises estimating the temperature Tₕ as Tₕ=Tₕ=\hat{f}_{T}_{₀}(Rₕ/\hat{R}_{T}_{₀}).

12. An apparatus comprising:
means for identifying a first plurality of estimates of a parameter A for a first plurality of print head elements in a first thermal print head, wherein the equation Tₕ=Tₛ+AP relates thermal print head element temperature Tₕ to a heat sink temperature Tₛ and input power P;
means for identifying a first average value of the first plurality of estimates;
means for identifying a second plurality of estimates of the parameter A for a second plurality of print head elements in a second thermal print head;
means for identifying a second average value of the second plurality of estimates; and
means for adjusting a first input energy provided to the first thermal print head and a second input energy provided to the second thermal print head based on a function of the first average value and the second average value.
